(19) United States
(12) Patent Application Publication
(10) Pub. No.: US 2007/0098129 A1
(43) Pub. Date: May 3, 2007

(54) PLASMA CONTAINMENT METHOD

(76) Inventors: W. Farrell Edwards, Logan, UT (US); Eric D. Held, Logan, UT (US)

Correspondence Address: Kunzler and Associates;Alan L. Edwards, Suite 600, 8 East Broadway, Salt Lake City, UT, 84111, US

(21) Appl. No.: 11/535,307

(22) Filed: Sep. 26, 2006

Related U.S. Application Data
(62) Division of application No. 10/804,520, filed on Mar. 19, 2004, now abandoned.
(60) Provisional application No. 60/456,832, filed on Mar. 21, 2003.

(51) Int. Cl. G21B 1/00

(52) U.S. Cl. 376/107

(57) ABSTRACT

A method for plasma containment is disclosed comprising varying the system energy subject to Maxwell's equations, momentum moment equations, and adiabatic equations of state, without imposing a quasi-neutrality condition. In one embodiment, electrons are confined by magnetic forces and ions by internal, electrostatic forces that arise due to charge separation of the two fluids. In one embodiment, input parameters for the energy variation process are selected so as to satisfy a plasma beta parameter condition, thereby reducing the number of control variables by one. The radial scale length for cylindrically symmetric plasmas in one-dimensional equilibrium is characterized by the electron skin depth. Such plasmas can be confined as a high aspect ratio toroid having compact dimensions. Applications of the invention include neutron generation, x-ray generation, and power generation.

### PRIORITY APPLICATIONS

This application is a divisional of U.S. patent application Ser. No. 10/804,520, filed 19 Mar. 2004, titled “Systems and Methods of Plasma Containment,” incorporated herein by reference. Application Ser. No. 10/804,520, in turn, claims priority benefit of U.S. provisional patent application No. 60/456,832, filed 21 Mar. 2003, titled “A Method of Obtaining Design Parameters for a Compact Thermonuclear Fusion Device,” incorporated herein by reference.

### BACKGROUND

1. Field

The present teachings generally relate to the field of plasma containment and more particularly, to systems and methods for establishing a stable plasma in a relatively compact containment chamber.

2. Description of the Related Art

Nuclear fusion occurs when two relatively low mass nuclei fuse to yield a larger mass nucleus and reaction products. Because a substantial amount of energy is associated with the reaction products, controlled nuclear fusion research is an ongoing process with efficient power generation being one of the important goals. For fusion to occur, two nuclei need to interact at a nuclear level after overcoming the mutually repulsive Coulomb barrier. Different methods can be used to promote such an interaction.

One widely-used method of promoting the fusion process is to provide a volume of plasma having the fusable ions at sufficient density and temperature. Such a plasma needs to be contained sufficiently long enough to allow the fusion reaction to occur. Preferably, such a containment substantially isolates the plasma from the surrounding environment to reduce heat loss.

One way to contain the fusionable plasma is to use magnetic fields to “pinch” and restrict the plasma to certain volumes. One magnetic confinement design commonly referred to as a “tokamak” restricts the plasma in a donut shaped (toroid) volume. Because many conventional magnetically confined fusion devices are geared toward power production, confinement volumes are designed to be large. Consequently, such large devices and various supporting components can be prohibitively complex and/or expensive to operate in widespread applications.

### SUMMARY

The foregoing drawbacks can be overcome by a containment method that enhances stability. Such a plasma can be designed and operated by determining a stable energy state of the system without imposing a quasi-neutrality condition; a contained plasma that includes a substantial induced electrostatic field will contribute significantly to the stability of the plasma. Compact devices based on such contained plasmas can be used in different applications, such as a neutron generator, an x-ray generator, and a power generator.

One aspect of the present teachings relates to a method for designing a plasma containment device, including generating a characterization of the energy of a plasma system having a distribution of electrons and a distribution of ions. The characterization includes an energy term associated with a bulk electrostatic field induced inside the plasma by dissimilarities between the distribution of electrons and the distribution of ions. The method further includes determining an equilibrium state associated with the characterization of the energy of the plasma system. The method further includes determining one or more plasma parameters associated with the equilibrium state.

In a further aspect, the present invention relates to a method of plasma containment, including providing a plasma system, comprising a plurality of charged first particles and a plurality of charged second particles, and creating a dissimilarity between the overall distributions of the first and second particles. In one embodiment, the method includes restricting the plasma to a first beta value, second beta value, and first particle skin depth, the first and second beta values depending on factors comprising average particle number density, average plasma temperature, and strength of a magnetic field established in the plasma. In one embodiment, the inverse of the first beta value is between approximately 0 and 22 and the inverse of the second beta value is between approximately 0 and 3, with a first particle skin depth of between 1 and 2 in a cylindrical configuration.

In a further aspect, the present invention relates to a method of plasma containment, including providing a plasma comprising a plurality of first particles and a plurality of second particles, confining the first particles substantially to a first volume, and confining the second particles substantially to a second volume, with the second volume being larger than and encompassing the first volume. In one embodiment, movement of the first particles creates an electric current, and confining the first particles substantially to the first volume comprises establishing a magnetic field in the plasma substantially perpendicular to the direction of the current. In a further embodiment, confining the second particles substantially to the second volume comprises separating the bulk distributions of the first particles and the second particles such that a bulk electrostatic field is created in the plasma between the first particles and the second particles.

In a further aspect, the present invention relates to a method of plasma containment, including providing a plasma comprising a plurality of charged first particles and a plurality of charged second particles, with the first particles establishing a current by acting as charge carriers in the plasma, and imposing a magnetic field on the plasma, the magnetic field being oriented substantially perpendicular to the current and acting on the first particles to create a dissimilarity in distributions between the first particles and the second particles within the plasma. In one embodiment, the first particles comprise electrons and the second particles comprise ions. In another embodiment, the first particles comprise ions and the second particles comprise electrons. In a further embodiment, the plasma is contained within a substantially cylindrical volume, the volume defining an axial direction and an azimuthal direction, which may constitute part of a toroid. The current may flow in a combined axial-azimuthal direction with the magnetic field oriented in a combined aximuthal-axial direction. The current flow and magnetic field may be oriented spirally.

In a further aspect, the present invention relates to a method of plasma containment, including providing a plasma comprising a plurality of charged first particles and a plurality of charged second particles, the first particles being charge carriers of a current in the plasma, establishing a magnetic field in the plasma that electromagnetically influences the position of the first particles more than it influences the position of the second particles, confining the first particles substantially to a first volume under the influence of the magnetic field, and maintaining at least a portion of the second particles outside the first volume. The position of the first particles may be electromagnetically influenced through a screw pinch. A bulk electrostatic field may be established within the plasma, and confining the second particles to a second volume (the first volume being smaller than and contained within the second volume), under the influence of the bulk electrostatic field.

### BRIEF DESCRIPTION OF THE DRAWINGS

FIG. 1 shows a contained plasma having a bulk electrostatic field induced inside the plasma due to a difference in the spatial distributions of electrons and ions;

FIG. 2 shows a process for determining a steady-state equilibrium of the plasma having the induced E-field;

FIG. 3 shows one embodiment of a contained plasma having a cylindrical symmetry such that the electron and ion densities depend on radial distance r from the Z axis;

FIG. 4A shows a Z-pinch containment of the cylindrically symmetric plasma of FIG. 3;

FIG. 4B shows a theta-pinch containment of the cylindrically symmetric plasma of FIG. 3;

FIG. 5 shows how a high aspect ratio toroidal containment may be estimated by a cylindrical geometry;

FIG. 6 shows one embodiment of an azimuthal magnetic field profile that provides a Z-pinching;

FIG. 7 shows one embodiment of a stable confinement of electrons by a magnetic force that substantially offsets forces due to E-field and pressure;

FIG. 8 shows one embodiment of a stable confinement of ions by an electrostatic force that substantially offsets a force due to pressure;

FIG. 9A shows one embodiment of a E-field profile that results from different spatial distributions of confined electrons and ions;

FIG. 9B shows the electron and ion distributions of FIG. 9A on a logarithmic scale;

FIG. 10 shows one embodiment of a temperature profile showing how heat loss to a containment wall located relatively close to the plasma can be reduced;

FIG. 11 shows one embodiment of a contour plot of a plasma parameter 1/α as a function of Y/Λₑ and temperature T;

FIG. 12 shows one embodiment of a magnetic field profile of an axially directed magnetic field that theta-pinches the plasma;

FIG. 13 shows examples of different electron and ion distributions in the theta-pinched plasma;

FIG. 14 shows an example of an E-field profile that results from the different electron and ion distributions of FIG. 13;

FIGS. 15A-C show various scales of plasma containment facilitated by electrostatic fields induced by separation of charges;

FIG. 15D shows one embodiment of an reversed plasma configuration where the ions are magnetically confined and the electrons are confined by an induced electrostatic field, wherein such a plasma can be scaled to an ion scale length that is substantially greater than the electron scale length;

FIGS. 16A and B show one embodiment of a Z-pinch plasma containment device that can yield different electron and ion distributions;

FIGS. 17A and B show one embodiment of a theta-pinch plasma containment device that can yield different electron and ion distributions; and

FIG. 18 shows one embodiment of a device that can emit various outputs based on a plasma where ion confinement is facilitated by a substantial electrostatic field.

These and other aspects, advantages, and novel features of the present teachings will become apparent upon reading the following detailed description and upon reference to the accompanying drawings. In the drawings, similar elements have similar reference numerals.

### DETAILED DESCRIPTION OF SOME EMBODIMENTS

The present teachings generally relate to systems and methods of plasma confinement at a relatively stable equilibrium. In one aspect, such a plasma includes a substantial internal electrostatic field that facilitates the stability and confinement of the plasma.

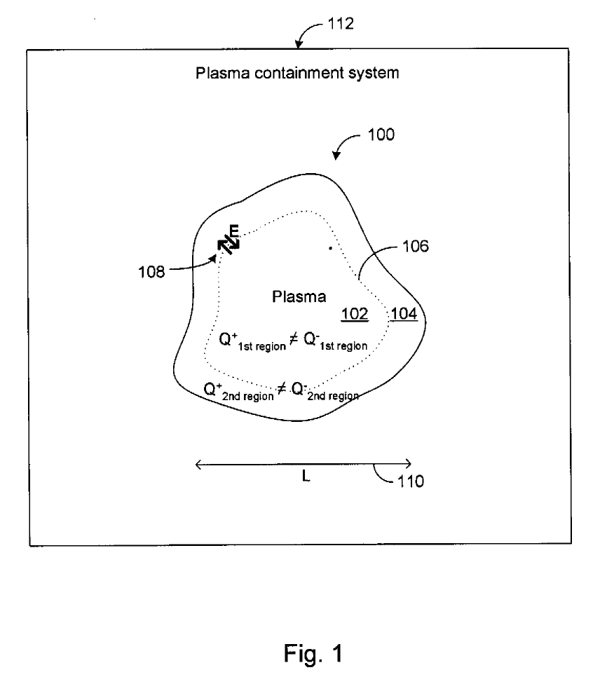

FIG. 1 shows a confined plasma 100 confined by a containment system 112. The plasma 100 defines a first region 102 substantially bounded by a boundary 106, and a second region 104 substantially bounded by the internal boundary 106 and the plasma's boundary. The plasma 100 has at least one dimension on the order of L as indicated by an arrow 110.

For the purpose of description, the plasma 100 can be characterized as a two-fluid system having an electron fluid and an ion fluid. It will be understood that the ion fluid can involve ions based on the same or different elements and/or isotopes. It will also be understood that the collective fluid-equation of characterization of the plasma herein is simply one way of describing a plasma, and is in no way intended to limit the scope of the present teachings. A plasma can be characterized using other methods, such as a kinetic approach, as will be apparent to those skilled in the art in light of this disclosure.

As shown in FIG. 1, the plasma 100 is depicted as being in an internally non-quasi-neutral stable state, where in the first region 102, the integrated charge due to electrons Q⁻_{first region} is different than the integrated charge due to ions Q⁺_{first region}. Similarly in the second region 104, Q⁻_{second region} is significantly different than Q⁺_{second region}. The excess charge in the first region 102 is of opposite sign and is approximately equal in magnitude to the excess charge in the second region 104, thereby making the plasma 100, as a whole, substantially neutral.

As further shown in FIG. 1, the formation of excess charges of different signs about the internal boundary 106 causes a formation of a bulk internal electrostatic field depicted as arrows 108. If one uses a convention where an E-field points away from a positive charge and towards a negative charge, the E-field 108 would point inward about the boundary 106 if the first region 102 has excess electrons (and the second region 104 has excess ions). Conversely, the E-field 108 would point outward about the boundary 106 if the first region 102 has excess ions. Both possibilities are described below in greater detail.

As described herein, formation of such electrostatic fields within the plasma 100 contributes to the energy of the plasma system. Determining a relatively-stable energy state of such a system yields plasma parameters, including selected ranges of a plasma dimension L, that are substantially different than that associated with conventional plasma systems. It is generally known that static electric fields in a plasma typically do not exist over a distance substantially greater than the Debye length. They are shielded out because of rearrangements of electrons and ions. This, however, is in the absence of external forces. In the present disclosure described herein, the plasma dimension L is generally greater than many Debye lengths; however this is permitted because of the presence of external forces due to, for example, presence of magnetic fields.

In the description below, various embodiments of plasma systems are described as cylindrical and toroidal systems. In the present disclosure a cylindrical geometry is used for a simplified description, and is not to be construed as limiting in any manner. Because at least some of the effects described herein depend on the scale of the contained plasma, many arbitrary shapes of a contained plasma can be used in connection with the present disclosure. As an example, the plasma 100 in FIG. 1 is depicted as a “generic” shaped volume manifesting the internal electrostatic field effect by being contained appropriately at a scale on the order of L and given the associated plasma parameters.

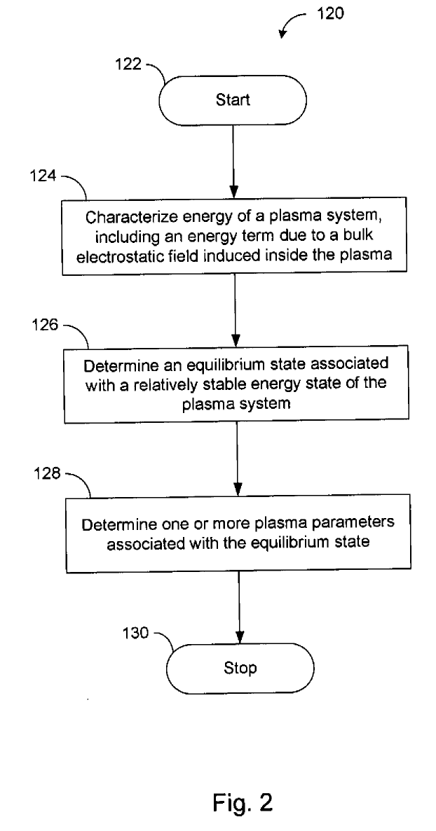

One aspect of the present teachings relates to a method for determining a plasma state that is relatively stable and wherein such stability is facilitated by formation of a relatively substantial internal electrostatic field. FIG. 2 shows one embodiment of a process 120 that determines such a stable state and one or more associated plasma parameters. The process 120 begins at a start state 122, and in a process block 124 that follows, the process 124 characterizes an energy of a plasma system. The energy characterization includes an energy term due to a substantial electrostatic field induced inside the plasma. In a process block 126 that follows, the process 120 determines an equilibrium state associated with a relatively stable energy state of the plasma system. In a process block 128 that follows, the process 120 determines one or more plasma parameters associated with the equilibrium state. The process 120 ends in a stop state 130.

One way to characterize the energy of the plasma system is to use a two-fluid approach without the quasi-neutrality assumption. In conventional approaches, quasi-neutrality is assumed such that electron and ion density distributions are substantially equal. In contrast, one aspect of the present teachings relates to characterizing the two-fluid system such that the electron and ion densities are allowed to vary independently substantially throughout the plasma. Such an approach allows the two fluids to be distributed differently, and thereby induce a bulk electrostatic field at an equilibrium state of the plasma.

For a plasma contained at least partially by a magnetic field, the energy U of the system can be expressed as an integral of a sum of an E-field energy term, a B-field energy term, kinetic energy terms of the two fluids, and energy terms associated with pressures of the two fluids. Thus,

$$U = \int [ \frac{{ɛ}_{0} {E}^{2}}{2} + \frac{{B}^{2}}{2 {μ}_{0}} + {\sum }_{s} ( \frac{{m}_{s} {n}_{s}}{2} {u}_{s}^{2} + {p}_{s} ) ] ⅆ V \qquad ( 1 )$$

where E represents the electric field strength, εₒ represents the permittivity of free space, B represents the magnetic field strength, μₒ represents the permeability of free space, the summation index and subscripts s denote the species electrons e or ions i, mₛ represents the mass of the corresponding species, nₛ represents the particle density of the corresponding species, uₛ represents the velocity of the corresponding species, pₛ represents the pressure of the corresponding species fluid, and dV represents the differential volume element of the volume of plasma.

For the purpose of description herein, it will be understood that terms “particle density,” “number density,” and other similar terms generally refer to a distribution of particles. Terms such as “electron density” and “electron number density” generally refer to a distribution of electrons. Terms such as “ion density” and “ion number density” generally refer to a distribution of ion. Furthermore in the description herein, terms such as “average particle density” and “average number density” are used to generally denote an average value of the corresponding distribution.

One way to further characterize the plasma is to treat the system as being a substantially collisionless and substantially fully-ionized plasma in a steady-state equilibrium. Moreover, each species of the two fluids can be characterized as substantially obeying an adiabatic equation of state expressed as
pₛ=Cₛnₛ^{γ} (2)
where the Cₛ represents a constant that can be substantially determined by a method described below, and γ represents the ratio of specific heats of the two species.

Temperatures associated with the two species can be determined through an ideal gas law relationship
pₛ=nₛkTₛ (3)
where k represents the Boltzmann's constant. Furthermore, both species are assumed to be substantially Maxwellian.

One way to further characterize the plasma is to express, for each species, a substantially collisionless, equilibrium force balance equation as
mₛnₛ(uₛ·∇)uₛ=qₛnₛ(E+uₛ×B)−∇pₛ (4)
where mₛ represents the particle mass of species s, qₛ represents the charge, uₛ represents the fluid velocity, and where the anisotropic part of the stress tensor can be and is ignored for simplicity for the purpose of description.

One way to further characterize the plasma is to express, for the system, Maxwell's equations as

$$\begin{matrix}∇ \cdot E = {\sum }_{s} {q}_{s} {n}_{s} / {ɛ}_{o} ; & ( 5 ) \\ ∇ \times B = {μ}_{O} {\sum }_{S} {q}_{S} {n}_{S} {u}_{S} ; & ( 6 ) \\ ∇ \times E = 0 ; and & ( 7 ) \\ ∇ \cdot B = 0. & ( 8 )\end{matrix}$$

As is known, Equation (5) is one way of expressing Poisson's equation; Equation (6) is one way of expressing Ampere's law for substantially steady-state conditions; Equation (7) is one way of expressing the irrotational property of an electric field which follows from Faraday's Law for substantially steady-state conditions; and Equation (8) is one way of expressing the solenoidal property of a magnetic field.

As is also known, Maxwell's equations assume conservation of total charge of a system. Accordingly, one can introduce a dependent variable Q defined as
∇·Q=nₑ (9)
to substantially ensure electron conservation by adopting appropriate boundary conditions in a manner described below. The electron density nₑ can further be characterized as obeying a relationship nₑ>0.

One way to determine a relatively stable confinement state of a plasma system is to determine an equilibrium state that arises from a first variation of the total energy of the plasma system as expressed in Equation (1) subject to various constraints as expressed in Equations (2)-(9). For the present invention, total energy may be defined as the combination of energy associated with pressure due to the temperature of the plasma particles, in this case ions and electrons, energy stored in the net electric field, energy stored in the net magnetic field, and kinetic energy associated with the movement of the plasma particles, in this case ions and electrons. In one such determination, the pressure term in Equations (1) and (4) can be eliminated by using Equation (2). The resulting constraints can be adjoined to the resulting energy expression U by using Lagrange multiplier functions. Such a variational procedure generally known in the art can result in a relatively complex general vector form of nonlinear differential equations.

One way to simplify the variational procedure without sacrificing interesting properties of the resulting solutions is to perform the procedure using cylindrical coordinates and symmetries associated therewith. The cylindrical symmetries can be used to reduce the independent variables of the system to one variable r. Accordingly, dependent variables of the system can be expressed as nᵢ, nₑ, Eᵣ, B_{z}, B_{θ}, Q, u_{iz}, u_{iθ}, u_{ez}, and u_{eθ}, where subscripts i and e respectively represent ion and electron species. The first six are state variables. Because derivatives of the last four (velocity components) do not appear in Equations (11A)-(11P) they can be treated as control variables in a manner described below.

Applying the cylindrical symmetries to the plasma system (where constraints ∇×E=0 and ∇·B=0 of Equations (7) and (8) are substantially satisfied identically), cylindrical coordinate expressions associated with Equations (4)-(6) and (9) can be adjoined to U of Equation (1) using Lagrange multiplier functions Mᵢ, Mₑ, M_{E}, M_{z}, M_{θ}, and M_{Q}. As the name implies, variations of the control variables may be considered as producing variations in the state variables as well as in the Lagrange multiplier functions.

The variation of U leads to first-order differential equations for the state variables and for the Lagrange multiplier functions, and to algebraic equations for the control variables. Such equations can conveniently be expressed as equations in dimensionless form using the following replacements: r→rΛₑ, uₛ→Uₛc, n→N₀n, E→EeN₀Λₑ/ε₀, B→BeN₀Λₑμ₀c. Cₛ→Cₛmₑc²N₀^{1-γ}, pₛ→pₛmₑN₀c², Q→QΛₑ and T→Tₛk/mc², where c represents the speed of light, N₀ represents the average particle density, e represents the magnitude of the electron charge, and Λₑ represents the electron skin depth expressed as
Λₑ=(mₑ/μₒN₀e²)^{1/2} . (10)

One system of equations that follows from the foregoing energy variation method can be expressed as

$$\begin{matrix}ⅆ {M}_{e} / ⅆ r = - {ru}_{ez}^{2} / 2 - {M}_{θ} {u}_{ez} - {ru}_{e θ}^{2} / 2 + {M}_{z} {u}_{e θ} - {M}_{E} - {M}_{Q} - {C}_{e} r γ {n}_{e}^{γ - 1} - {{M}_{e} ( {C}_{e} γ )}^{- 1} ( 2 - γ ) {n}_{e}^{1 - γ} ( {E}_{r} + {u}_{e θ} {B}_{z} - {u}_{ez} {B}_{θ} + {u}_{e θ}^{2} / r ) & ( 11 A ) \\ ⅆ {M}_{i} / ⅆ r = - {ru}_{iz}^{2} / 2 - {M}_{θ} {u}_{iz} - {ru}_{i θ}^{2} / 2 + {M}_{z} {u}_{i θ} + {M}_{E} - {C}_{i} r γ {n}_{i}^{γ - 1} + {{M}_{i} ( {C}_{i} γ )}^{- 1} ( 2 - γ ) {n}_{i}^{1 - γ} ( {E}_{r} + {u}_{i θ} {B}_{z} - {u}_{iz} {B}_{θ} + {u}_{i θ}^{2} / r ) & ( 11 B ) \\ ⅆ {M}_{E} / ⅆ r = - {rE}_{r} - {M}_{e} {{n}_{e}^{2 - γ} ( {C}_{e} γ )}^{- 1} + {M}_{i} {{n}_{i}^{2 - γ} ( {C}_{i} γ )}^{- 1} - {M}_{E} / r & ( 11 C ) \\ ⅆ {M}_{z} / ⅆ r = - {rB}_{z} - {M}_{e} {n}_{e}^{2 - γ} {{u}_{e θ} ( {C}_{e} γ )}^{- 1} + {M}_{i} {n}_{i}^{2 - γ} {{u}_{i θ} ( {C}_{i} γ )}^{- 1} & ( 11 D ) \\ ⅆ {M}_{θ} / ⅆ r = - {rB}_{θ} + {M}_{e} {n}_{e}^{2 - γ} {{u}_{ez} ( {C}_{e} γ )}^{- 1} - {M}_{i} {n}_{i}^{2 - γ} {{u}_{iz} ( {C}_{i} γ )}^{- 1} + {M}_{θ} / r & ( 11 E ) \\ ⅆ {M}_{Q} / ⅆ r = {M}_{Q} / r & ( 11 F ) \\ {u}_{ez} = \{ {M}_{e} {n}_{e}^{1 - γ} {{B}_{θ} ( {C}_{e} γ )}^{- 1} - {M}_{θ} \} / r & ( 11 G ) \\ {u}_{e θ} = \{ {M}_{z} - {M}_{e} {{n}_{e}^{1 - γ} ( {rC}_{e} γ )}^{- 1} \} / \{ r + 2 {M}_{e} {{n}_{e}^{1 - γ} ( {rC}_{e} )}^{- 1} \} & ( 11 H ) \\ {u}_{iz} = \{ {M}_{i} {n}_{i}^{1 - γ} {{B}_{θ} ( {C}_{i} γ )}^{- 1} - {M}_{θ} \} / r & ( 11 I ) \\ {u}_{i θ} = \{ {M}_{z} - {M}_{i} {{n}_{i}^{1 - γ} ( {rC}_{i} γ )}^{- 1} \} / \{ r + 2 {M}_{i} {{n}_{i}^{1 - γ} ( {rC}_{i} )}^{- 1} \} & ( 11 J ) \\ ⅆ {n}_{e} / ⅆ r = - {( {C}_{e} γ )}^{- 1} {n}_{e}^{2 - γ} ( {E}_{r} + {u}_{e θ} {B}_{z} - {u}_{ez} {B}_{θ} - {u}_{e θ}^{2} / r ) & ( 11 K ) \\ ⅆ {n}_{i} / ⅆ r = {( {C}_{i} γ )}^{- 1} {n}_{i}^{2 - γ} ( {E}_{r} + {u}_{i θ} {B}_{z} - {u}_{iz} {B}_{θ} + {u}_{i θ}^{2} / r ) & ( 11 L ) \\ ⅆ {E}_{r} / ⅆ r = - {E}_{r} / r + {n}_{i} - {n}_{e} & ( 11 M ) \\ ⅆ {B}_{z} / ⅆ r = {n}_{e} {u}_{e θ} - {n}_{i} {u}_{i θ} & ( 11 N ) \\ ⅆ {B}_{θ} / ⅆ r = - {B}_{θ} / r + {n}_{i} {u}_{iz} - {n}_{e} {u}_{ez} & ( 11 O ) \\ ⅆ Q / ⅆ r = - Q / r + {n}_{e} & ( 11 P )\end{matrix}$$

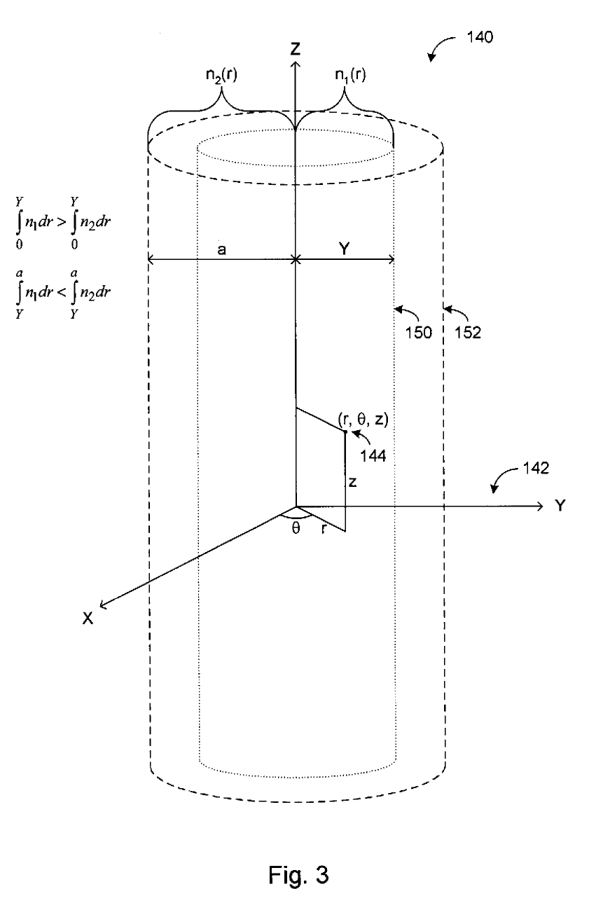

One set of boundary conditions (at r=0 and r=a, where a is defined as an outer boundary in FIG. 3) includes Eᵣ(0)=Eᵣ(a)=0, B_{z}(a)=B₀, and B_{θ}(0)=0. Boundary conditions can further include Q(O)=0 and Q(a)=N₀a/2 relating to charge conservation for individual species. Conditions at each boundary can further be imposed on each state variable or its corresponding Lagrange multiplier function so as to be substantially equal to zero if there is substantially no state-variable condition. It follows that Mₑ(0)=Mₑ(a)=Mᵢ(0)=Mᵢ(a)=M_{z}(0)=0.

In one implementation of a method for determining a stable equilibrium of the foregoing cylindrical plasma system, input parameters (expressed in dimensional form) for solving the system of equations (Equations (11A-P)) include the cylindrical radius a, the average particle number density N₀ substantially equal for both species, the axial magnetic field at the boundary a such that B_{z}(a)=B₀, the net axial current I, and a temperature value T₀ for both electrons and ions that is the temperature taken at that value of r at which nₛ=N₀. Using these input parameters, one can determine that B_{θ}(a)=μ₀I/(2πa).

Furthermore, the values of Cₛ can be determined by combining the adiabatic equation of state from Equation (2) and the ideal gas law from Equation (3) so as to yield Cₛ=nₛ^{1-γ}kTₛ. Thus, Cₛ=N₀^{1-γ}kT₀ when evaluated at the value of r where nₛ=N₀ and Tₛ=T₀. The electron and ion average temperatures may be different, which would result in different values of Cᵢ and Cₑ. For the examples of the present disclosure, they are taken to be substantially the same, i.e., T₀. Such a simplification for the purpose of description should not be construed to limit the scope of the present teachings in any manner.

Another useful set of input parameters can be obtained by replacing B₀ with a plasma beta value defined as β=N₀kT₀/(B₀²/2μ₀) and by replacing I with another beta value a α=N₀kT₀/(Bθ(a)²/2μ₀), where I=2πaB_{θ}(a)/μ₀. Note that 1/β=0 corresponds substantially pure Z-pinch, and 1/α=0 corresponds to a substantially pure theta-pinch. A screw-pinch corresponds to substantially nonzero values for both 1/α and 1/β.

The foregoing energy variational method yields a description of the plasma system by twelve first-order coupled nonlinear ordinary differential equations, four algebraic equations, and one inequality condition (nₑ>0), with sixteen unknowns. Numerical solutions to such a system of equations can be obtained in a number of ways. Solutions disclosed herein are obtained using a known differential equation solving routine such as BVPFD that is part of a known numerical analysis software IMSL.

FIG. 3 now shows one embodiment of a cylindrically shaped contained plasma 140 that embodies a possible solution to the energy variation analysis of the two-fluid system described above. As a reference, the cylindrical plasma 140 is superimposed with a cylindrical coordinate system 142. An arbitrary point 144 on the coordinate system 142 can be expressed as having coordinates (r, θ, z).

The plasma 140 defines a first cylindrical volume 150 extending from the Z-axis to r=Y, and a second cylindrical volume 152 extending from the Z-axis to r=a. The first volume 150 generally corresponds to a region of the plasma 140 where the first species of the two fluids is distributed as n₁(r). The second volume 152 generally corresponds to a region of the plasma 140 where the second species of the two fluids is distributed as n₂(r).

In general, the first and second species are distributed such that

$$\begin{matrix}{\int }_{0}^{Y} {n}_{1} ⅆ r > {\int }_{0}^{Y} {n}_{2} ⅆ r , & ( 12 A ) \\ {\int }_{Y}^{a} {n}_{1} ⅆ r = 0 , & ( 12 B ) \\ {\int }_{0}^{a} {n}_{1} ⅆ r = {\int }_{0}^{a} {n}_{2} ⅆ r . & ( 12 C )\end{matrix}$$

That is, the first region 150 has more of the first species than the second species, and the portion of the second region 152 outside of the first region has substantially none of the first species. As Equation (12C) shows, the total number of particles in the two species is substantially the same in one embodiment.

In some embodiments, substantially all of the first species is located within the first region 150 such that r=Y defines a boundary for the first species. Consequently, the region Y<r<a has substantially none of the first species, and is populated by the second species by an amount ΔN. Since the total numbers of the first and second species are substantially the same in one embodiment, the value of ΔN is also representative of the excess number of the first species relative to the second species in the first region 150.

In some embodiments, as described below in greater detail, the first species can be the electrons, and the second species the ions when a plasma is contained within one or more selected ranges of value for the boundary r=Y. In other embodiments, as also described below in greater detail, the first species can be the ions, and the second species the electrons when the plasma is contained in one or more other selected ranges of value for the boundary r=Y.

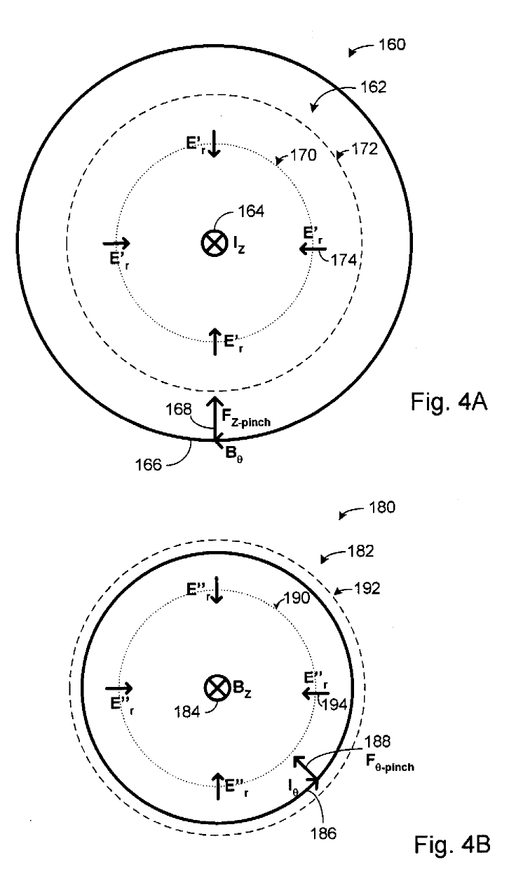

FIGS. 4A and B show two methods of confining a cylindrical geometry plasma by magnetic fields, thereby causing the electron and ion distributions to become different in a manner described above in reference to FIG. 3. FIG. 4A shows one embodiment of a Z-pinch confinement 160, and FIG. 4B shows one embodiment of a theta-pinch confinement 180. Although the Z-pinch and theta-pinch methods are shown separately, it will be understood that these two pinches can be combined to form what is commonly referred to as a screw-pinch.

As shown in FIG. 4A, the Z-pinch 160 can be achieved when an axial current I_{Z} 164 is established in a plasma 172. Such a current can be established in a number of ways, including an example method described below. The axial current I_{Z} 164 causes formation of an azimuthal magnetic field B_{θ} 166 that asserts a radially inward force F_{Z-pinch} 168 on the moving charged particles of the plasma 162.

As described below in greater detail, when the radial dimension of the plasma is selected in certain ranges, motion of one species relative to the other species can be enhanced and thereby be more subject to the magnetic pinching force. Thus, as shown in FIG. 4A, an inner first region 170 of the plasma 162 includes substantially all of the magnetically contained species. In FIG. 4A, the magnetically confined species is depicted as being the electrons. As such, the ions are distributed within a second region 172 that includes and radially extends beyond the first region 170. Such a distribution of the two species can induce a substantial internal electrostatic field 174 denoted as E′ᵣ. The electrostatic field 174 facilitates containment of the ions substantially within the second region 172. It will be understood that if the ions are made to be magnetically confined within the first region 170, the electrostatic field 174 is reversed in direction, and the electron confinement can be facilitated by such an electrostatic field.

As shown in FIG. 4B, the theta-pinch 180 can be achieved when a steady azimuthal current I_{θ} 186 is established in the plasma. The current I_{θ} 186 can be produced in a number of ways including an example method described below. The axial magnetic field B_{Z} 184 asserts a radially inward force F_{θ-pinch} 188 on the azimuthal current I₇₄ 186 and thereby facilitates containment of the plasma 182.

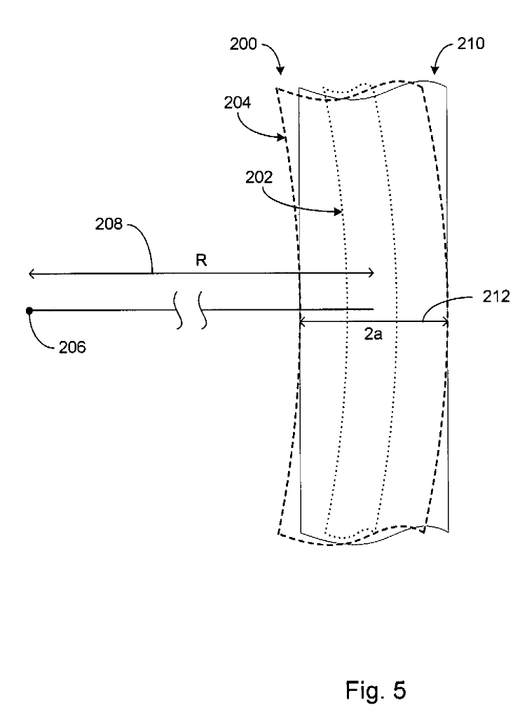

FIG. 5 now shows that a plasma confinement solution described above in the context of cylindrical geometry can be used to approximate a design of a toroidal geometry containment device. A section of a toroidally confined plasma 200 is shown superimposed with a section of a similarly dimensioned (tube dimension) cylindrically confined plasma 210. The toroid 200 is depicted to be centered about a center point 206 such that the center of the toroidal “tube” (having a radius a, known as the toroid's minor radius) is separated from the center point 206 by a distance R (indicated by arrow 208). As will be apparent to those skilled in the art in light of this disclosure, the axial component or direction of the cylindrically confined plasma 210 corresponds to a toroidal component or direction of the toroidally confined plasma 200, with the azimuthal component or direction of the plasma 210 corresponding to a poloidal component or direction of the plasma 200.

One can see that when the distance R is relatively large compared to a, such as in a high aspect ratio (R/a) toroid, a given segment of the toroid geometry can be approximated by the cylindrical geometry. Thus, one can obtain design parameters using a cylindrical geometry, and apply such a solution to designing of a toroidal device. As is known in the art, such a cylindrical approximation provides a good base for a toroidal design. One way to correct for the differences between the toroidal and cylindrical geometries is to provide a corrective external field, often referred to as a vertical field that inhibits the plasma toroid radius R from increasing due to magnetic hoop forces, to confine the plasma.

Thus as shown in FIG. 5, a toroidally confined plasma 200 includes a toroidally shaped first region 202 and a toroidally shaped second region 204 that are arranged with respect to each other in a manner similar to that of a cylindrical plasma. As with the cylindrical plasma, the first region may be defined by electrons in some embodiments, and also by ions in other embodiments.

The foregoing analysis of the cylindrical plasma includes a one-dimensional (r) analysis using the energy variation method. As described above in reference to FIG. 5, such one-dimensional analysis can provide a basis for estimating the design and characterization of a high aspect ratio toroid. A more generalized three-dimensional analysis of, for example, a general toroid or a chamber of any shape, in a similar manner is expected to yield similar results where parts of the electrons and ions separate, thereby causing a substantial electrostatic field within the plasma.

One aspect of the present teachings relates to a scale of a contained plasma having a substantial electrostatic field induced therein. Various results of the foregoing energy variational procedure are described in the context of cylindrical symmetry. It will be appreciated, however, that such results can also be manifested in other shapes of contained plasma having a similar scale.

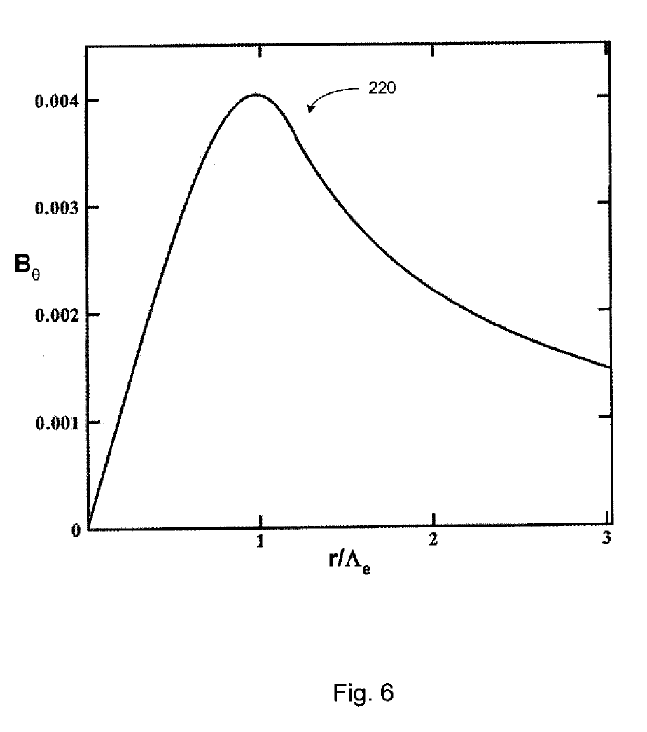

FIGS. 6-10 show various plasma parameters that result from the cylindrically symmetric energy variational analysis for a Z-pinched system with a set of inputs. The plasma is defined as a cylinder having an outer diameter a of approximately three times the skin depth (scale length) Λₑ. With such a selection of the scale of the plasma, example input parameters include N₀=10¹⁹/m³, T₀=5 keV, 1/α=2.51 (thereby defining the magnetic field strength B_{θ}(a) and the axial current I), and 1/β=0 (thereby setting B_{z}(a)=B₀=0). The corresponding electron skin depth parameter Λₑ=(mₑ/μₒN₀e²)^{1/2} (Equation (10), and depending on the input parameter N₀) is approximately 1.7 mm.

The foregoing input parameters result in a contained plasma where the electrons are pinched by magnetic forces thereby giving rise to electron-ion charge separation. Consequently, the electrons are distributed substantially within the inner region of the cylinder (first region 150 in FIG. 3), and the ions are distributed partially in the first region 150 and partially beyond the boundary (r=Y) of the first region 150. Such a charge separation produces a static electric field that confines the ions. The resulting charge gradient scale length is relatively small—on the order of the electron skin depth as expressed in Equation (10).

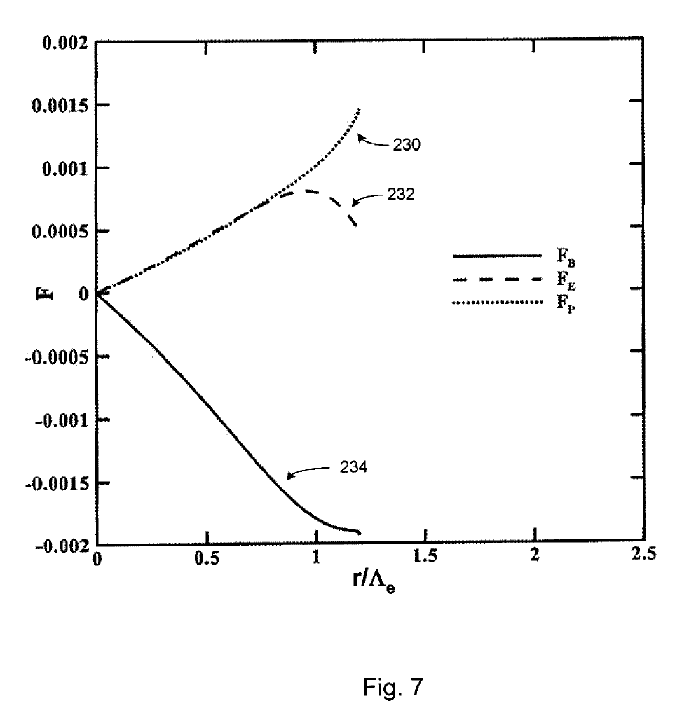

FIG. 6 shows a profile 220 of the azimuthal magnetic field strength B_{θ} as a function of a dimensionless variable r/Λₑ. Such a magnetic field confines the electrons as shown in FIG. 7, where the forces acting on the electrons are shown as a function of r/Λₑ. In the force profile of FIG. 7, a positive value of a force is indicative of a radially outward directionality, and a negative value the opposite. Thus, a kinetic pressure force 230 that tends to make the electron fluid want to expand is directed outward. An electrical force 232 on the electrons is caused by the inwardly directed electrostatic field induced in the plasma by the foregoing charge gradient. A magnetic force 234 that confines the electrons is thereby directly inward, and offsets the sum of outwardly directed pressure and electrical forces 230, 232 over much of the electron volume. In the example electron confinement shown in FIG. 7, the pressure and electrical forces 230 and 232 have substantially similar magnitudes over much of the electron volume. In one embodiment shown in FIG. 7, the electron forces profiles do not extend beyond r=Y because there are substantially no electrons beyond that boundary.

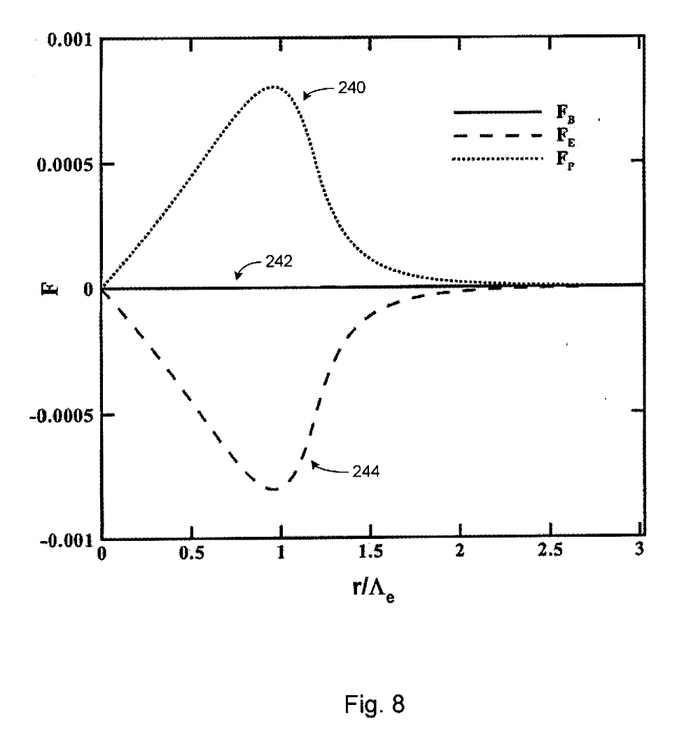

FIG. 8 shows profiles of forces acting on the ions. A magnetic force 242 on the ions is substantially negligible due to the relatively low velocity of the moving ions. A kinetic pressure force 240 that tends to make the ion fluid want to expand is directed outward. An electrical force 244 on the ions is directed inward, and is caused by the inwardly directed electrostatic field induced in the plasma by the foregoing charge gradient. One can see that the electrical force 244 is significant and generally offsets the pressure force 240. Thus, the electric field produced from the charge separation is the primary ion confining force.

It will be appreciated that while the magnetic field provides an initial confinement mechanism for the plasma, the internally-produced electric field plays an important and substantial role in establishing a stable plasma equilibrium. The force profiles shown in FIGS. 7 and 8 and the resulting steady-state equilibrium of the plasma underscore the importance of the electric field. Such a stable equilibrium state facilitated by the electric field does not appear if the plasma is quasi-neutral. Hence, the importance of not a making the quasi-neutrality assumption in designing a plasma containment device is demonstrated.

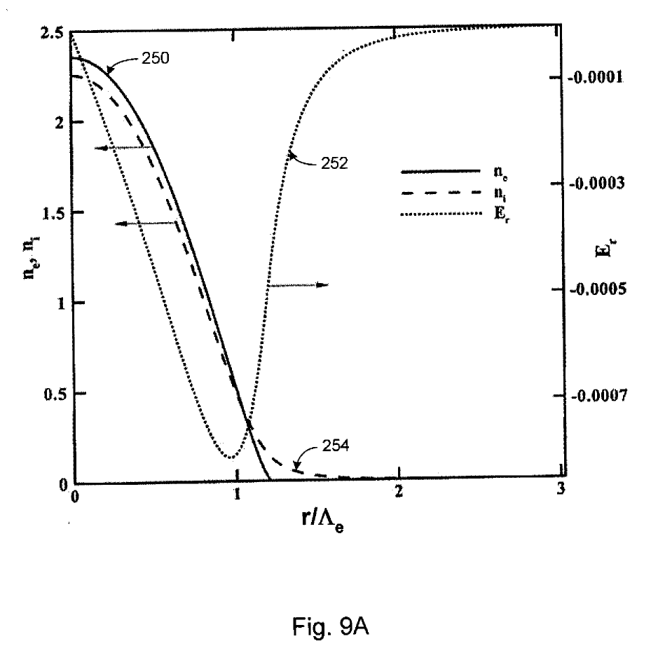

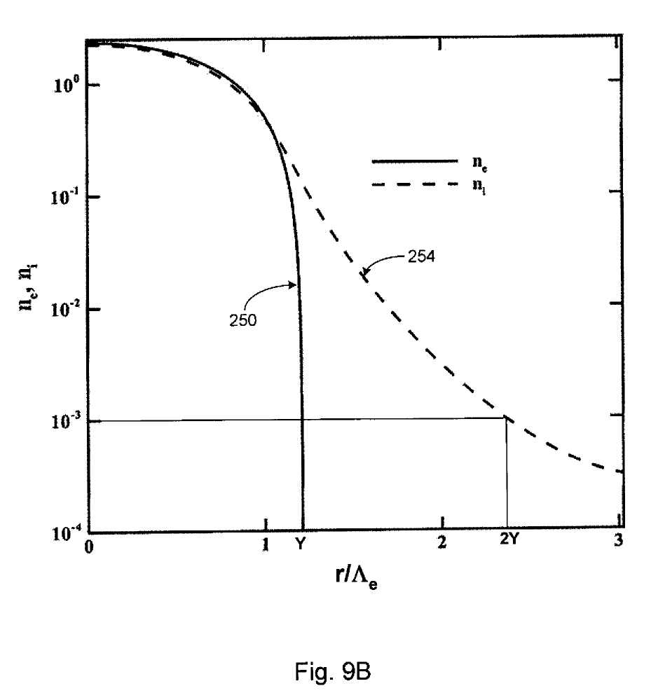

FIG. 9A now shows an electron distribution 250 and an ion distribution 254 that give rise to an electric field profile 252. The three curves 250, 252, and 254 are shown as functions of a dimensionless variable r/Λₑ. The vertical scale for the electron and ion distributions 250 and 254 is in terms of the average density value N₀. The electric field profile 252 gives rise to the electrical force profiles described above in reference to FIGS. 7 and 8. As the electron distribution 250 shows, the electrons are distributed substantially within the boundary Y at approximately 1.2θₑ. As defined in Equation (10), the value of Λₑ=(mₑ/μ₀N₀e²)^{1/2} is approximately 1.7 mm when N₀=10¹⁹/m³. Thus, the value of the electron boundary Y for the example plasma of FIG. 9A is approximately 2.04 mm.

As shown in FIG. 9A, the electron and ion distributions overlap over at least a portion of the plasma about the axis. As further shown in FIG. 9A, the electrons are substantially confined to a restricted volume defined by the electron boundary Y. Thus, such a restricted volume can be characterized by a volume scale length such as the electron skin depth Λₑ.

As further shown in FIG. 9A, the ion distribution 254 extends beyond the boundary Y. Beyond the Y boundary, the ion fluid can be characterized as satisfying single fluid equations that can easily be obtained by modifying the set of equations described above. One way to obtain a substantially complete ion distribution and its associated plasma parameter(s) is to match the two sets of equations (r<Y and r>Y) at the boundary Y by adjusting input parameters until the dependent variables and their derivatives are substantially continuous at Y.

One aspect of the present teachings relates to a plasma system having an induced separation of charges, as shown by the electron and ion distributions 250 and 254, thereby causing formation of the radially directed electric field profile 252 that substantially overlaps with the plasma volume. Such a coverage of the induced electrostatic field can be achieved in contained plasma systems where the boundary Y for electrons has a dimension on the order of the electron scale length Λₑ.

For a system to lie within an energy well sufficiently deep to provide a robust confinement for one embodiment, the cylinder radius can lie within a range near the value of the electron scale length (skin depth) Λₑ In the example embodiment described above in reference to FIGS. 6-9, Y≈1.2Λₑ, and the electric field extends over a substantial portion of the plasma.

A relatively large radius configuration (e.g., Y=6Λₑ) can result in a substantial electric field being induced near the outer region of the plasma cylinder. An energy well associated with such a configuration can be relatively shallow when compared to the Y≈1.2Λₑ case. Also, a relatively small radius configuration (e.g., Y=0.3Λₑ) can result in confinement being lost.

Thus in one embodiment, a plasma confinement that is facilitated by the induced electrostatic field has a value of Y that is in a range of approximately 1 to 2 times the electron scale length Λₑ. In one embodiment, a value of Y around 1.2Λₑ appears to provide a near optimal confinement condition. For a plasma with N₀=10¹⁹/m³ (as with the example plasma of FIGS. 6-9), Λₑ=1.7 mm, and Y=(1.2)(1.7)≈2.04 mm. Since a=3Λₑ for the example plasma, the outer radius of the contained plasma is approximately 5.1 mm. One can see that such a compact dimension of a stable, contained plasma can be used in a number of applications, some of which are described below in greater detail.

The plasma is contained such that energy and/or particle loss(es) from the plasma to a wall defining a containment volume is reduced. One way to achieve such energy/particle loss reduction is to reduce the number of plasma particles coming into contact with the wall. As shown in FIG. 9B, where the electron and ion distributions 250 and 254 are plotted on a logarithmic scale, the ion number density 254 reaches a value of approximately 0.001 N₀ when r/Λₑ is approximately twice the value of Y. Thus for an embodiment where Y=1.2Λₑ≈2.04 mm, the ion number density reaches approximately 0.1% of the average density value N₀ at r≈(2.04)(2)=4.1 mm.

As described above, for a plasma containment design where a=3Λₑ, the outer radius a is approximately 5.1 mm for the Y=1.2Λₑ case. For such a system, a wall can be positioned at a location r>5.1 mm and still allow construction of a relatively small containment device. Moreover, the ion number density at r>5.1 mm (3Λₑ) is substantially lower than the 0.1% level described above. Thus, the number of ions coming into contact with the wall at r>5.1 mm and transferring energy thereto and/or interacting therewith is reduced even more.

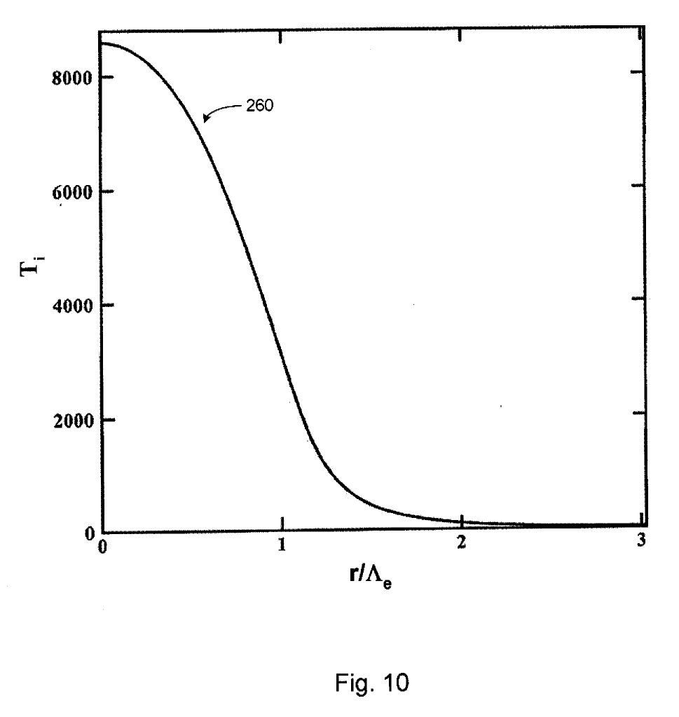

FIG. 10 shows a plasma temperature profile 260 as a function of r/Λₑ for the example plasma described above in reference to FIGS. 6-9. One can see that the temperature is reduced substantially at 3Λₑ(5.2 mm). The temperature is even lower for the region r>3Λₑ. Thus, heat transfer from the plasma to the wall located at r>3Λₑ is reduced, since the plasma particles that come into contact with the wall have substantially low kinetic energies when compared to the inner portion of the plasma.

The example plasma described above in reference to FIGS. 6-10 advantageously includes the induced electrostatic field. Such a plasma includes electrons distributed substantially within a boundary Y that is in a range of approximately 1-2Λₑ so as to allow the electric field to cover a substantial portion of the plasma volume. Such a significant presence of the electric field facilitates a robust containment of the plasma at a scale on the order of the electron scale length (skin depth). Investigation of such a plasma system shows that such features of the contained plasma at such a scale hold when the input parameters are varied significantly. As an example, similar advantageous electric field facilitated confinement holds within a factor of approximately 2 when the average number density N₀ changes by a factor of approximately 10 and when the input temperature value T₀ changes by a factor of approximately 30. Thus, design of a plasma containment having a dimension on the order of electron scale length can be made relatively flexible.

The present disclosure reveals substantial electric fields due to excess electrons in the r<Y region and ions being substantially the only species in the r>Y region. As described above, numerical solutions can be obtained by solving Equations (11A)-(11P) for r<Y and substituting Y for a in the boundary conditions. One can solve the modified set (for ions) for r>Y and replacing 0 by Y in the boundary conditions and then matching the solutions of the two sets at r=Y. In one embodiment, the number density of the magnetically bound species becomes substantially zero at r=Y.

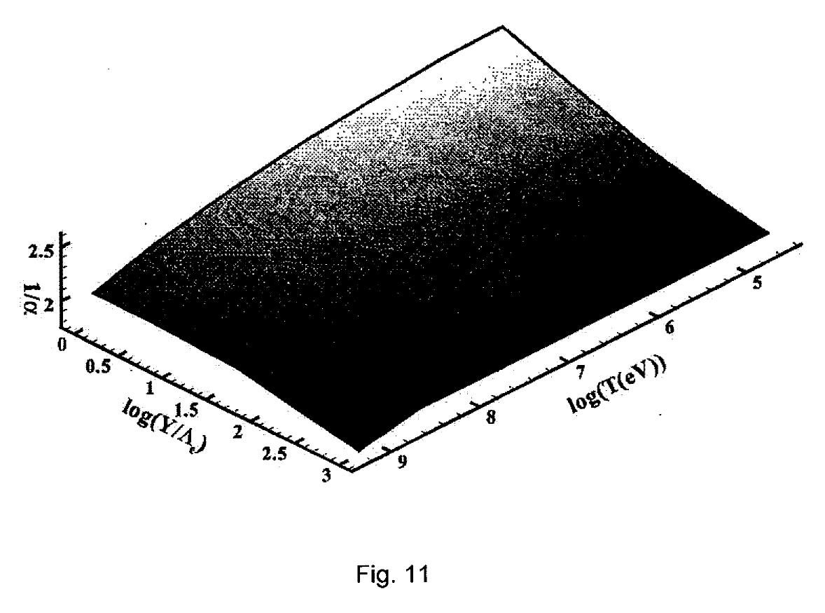

In one embodiment, accomplishing such a matching process can place an additional restriction on the input or control parameters that can be expressed in terms of 1/α and 1/β. For example, in the cylindrical coordinate treatment of the Z-pinch embodiment, 1/α, which can be obtained from N₀, T₀, and B₀, is approximately 2 (for typical fusion plasma parameter values). A more precise value of 1/α can be expressed as a slowly varying function of T₀ and n₀. For the example cylindrical geometry, an approximate value can be obtained from an example contour plot of 1/α as a function of Y/Λₑ and temperature T, such as that of FIG. 11. For a theta-pinch, screw-pinch, ions moving, other geometries, or combinations thereof, the appropriate restriction can be obtained either experimentally or by solving the equations similar to Equations (11A)-(11P) and the appropriate modified set for r>Y. In one embodiment, the number density of the current carrying species approaches approximately zero at the boundary r=Y. In one embodiment where both species can carry substantial current, similar method can be applied to obtain a solution.

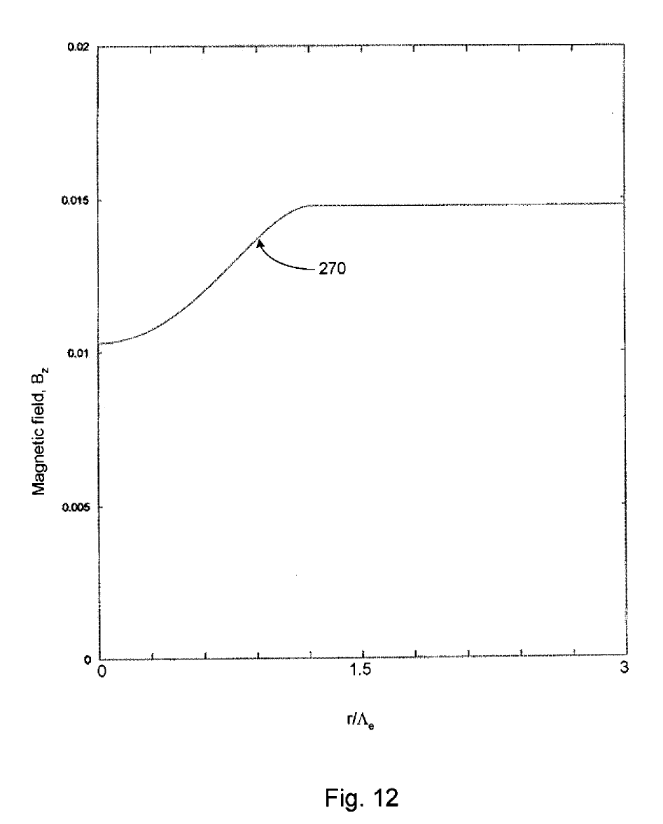

The example plasma described above in reference to FIGS. 6-10 is Z-pinched. Similar electrostatic field effects can also arise when a plasma is theta-pinched. FIGS. 12-14 shows an example result of the energy variational method described above.

For the theta-pinch example, an outer diameter a of approximately 3Λₑ is used. Furthermore, input parameters N₀=10¹⁹/m³, T₀=10⁴ keV, 1/α=0, and 1/β=20.5 are used. The corresponding electron scale length Λₑ=(mₑ/μₒN₀e²)^{1/2} is approximately 1.7 mm.

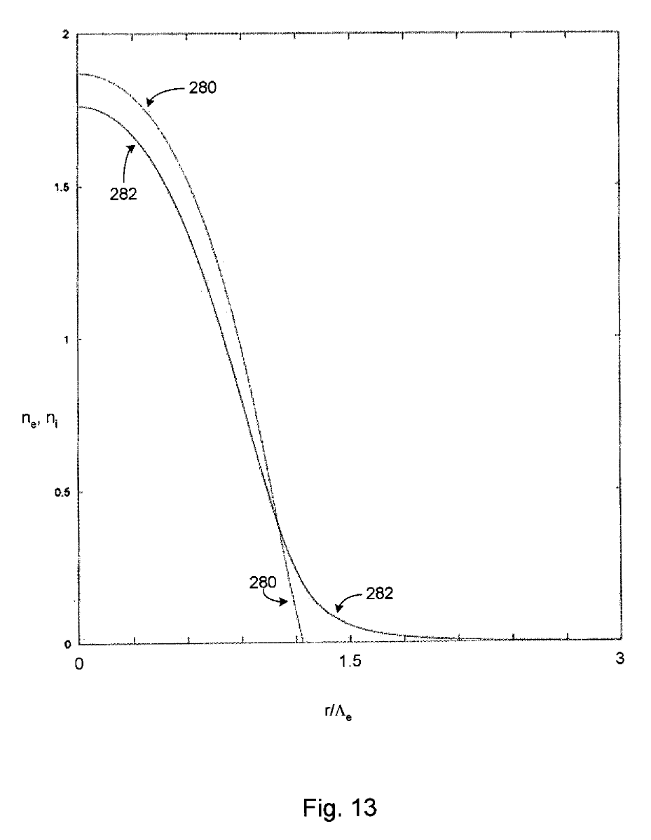

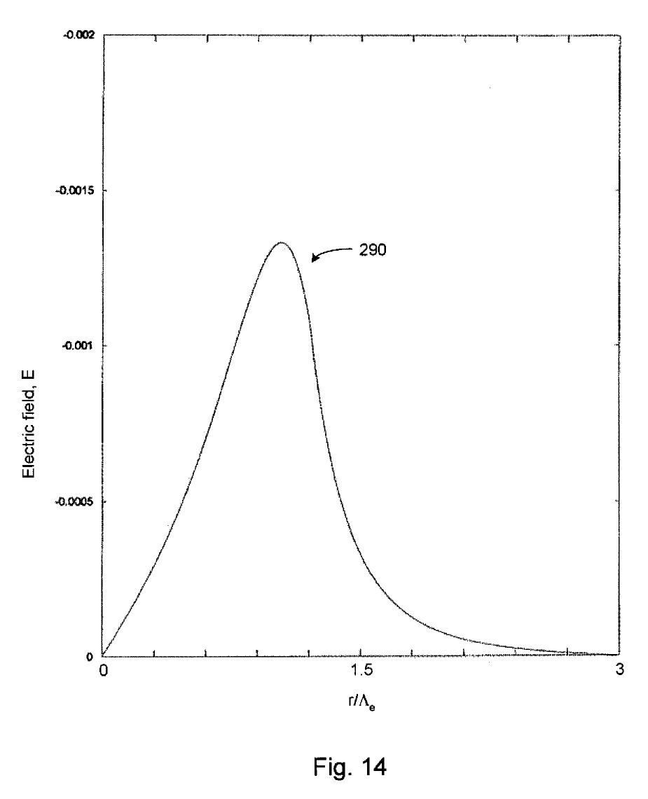

Based on the foregoing example inputs, FIG. 12 shows an axial magnetic field profile 270 as a function of distance from the Z axis. Such a magnetic field theta-pinch can confine the plasma such that an electron distribution 280 and an ion distribution 282 are formed as shown in FIG. 13. Separation of charges due to such distributions can cause a substantial electrostatic field profile 290 as shown in FIG. 14.

The foregoing example theta-pinch confinement results in the value of Y being approximately 2.04 mm. Thus, a theta-pinched plasma with a confinement dimension on the order of the electron scale length Λₑ can provide the various advantageous features described above in reference to the Z-pinched plasma system.

As previously described, a screw-pinch can be achieved by a combination of Z and theta pinches. Thus, an energy variational analysis similar to the foregoing can be performed with 1/α≠0 and 1/β≠0 to yield similar results where a substantial electrostatic field is induced by separation of charges. Furthermore, a screw-pinched plasma with a confinement dimension on the order of the electron scale length Λₑ can provide similar advantageous features described above in reference to Z and theta pinched plasma systems. Screw-pinch magnetically confined plasmas are generally regarded as more stable than simple Z- or theta-pinches. It is expected that screw-pinch embodiments of the present teachings will share the various features disclosed herein.

As also described, magnetically confining a plasma in a dimension on the a order of the plasma's electron scale length results in separation of charges, thereby inducing a substantial electrostatic field over a substantial portion of the plasma volume. Such an electric field can be characterized so as to correspond to a depth of an energy well associated with a stable equilibrium. Moreover, the energy well depth is expected to be relatively deep when the electron fluid radius Y is in a range of approximately 1-2Λₑ. Such relatively deep energy well of the equilibrium provides a relatively stable confined plasma. Such stability of a confined plasma at a value of Y of approximately 1-2 Λₑ, however, does not preclude a possibility that magnetic confinement at larger values of Y can have its stability facilitated significantly by the induced electrostatic field.

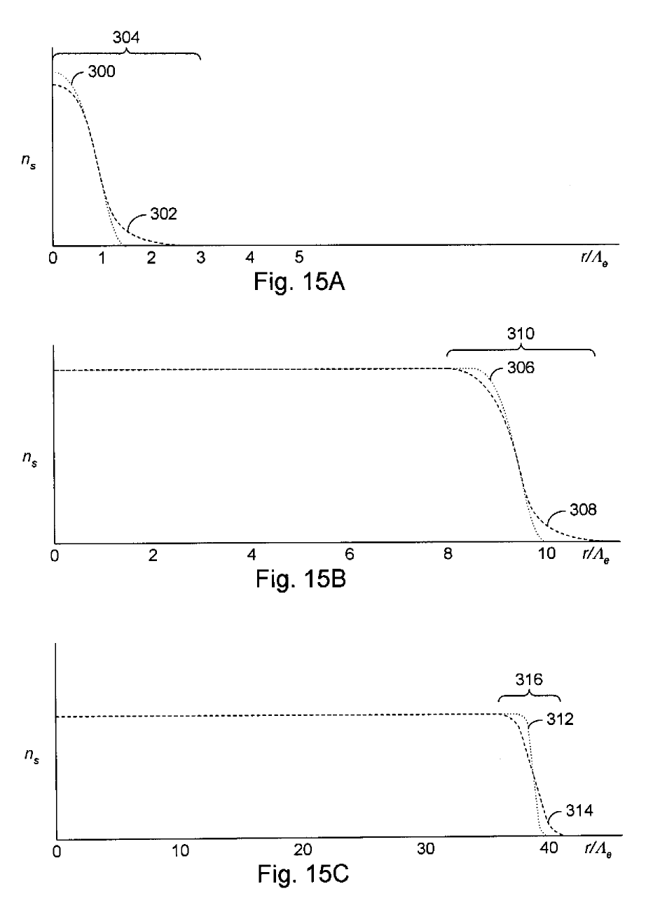

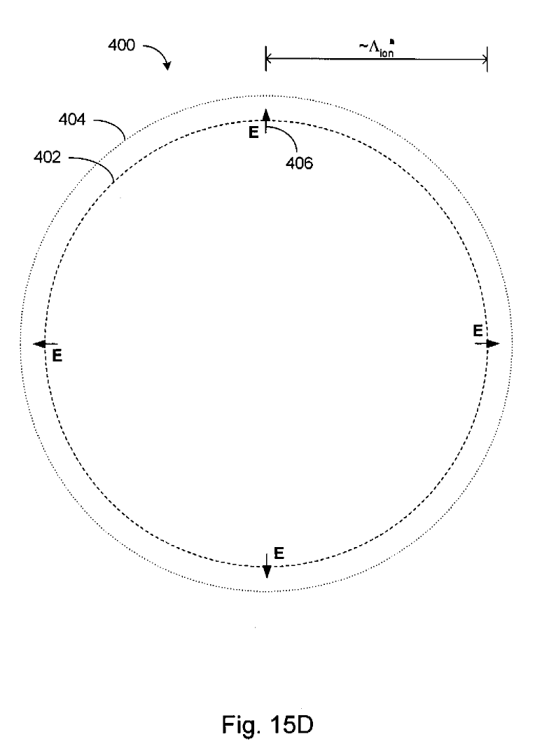

One aspect of the present teachings relates to a magnetically confined and relatively stable equilibriated plasma at different dimensional scales. FIGS. 15A-C show electron and ion distributions for different plasma sizes. While the larger sized plasma systems may not yield equilibria that are as stable as the case where Y=1-2 Λₑ, such equilibria may nevertheless have sufficient stabilities that are facilitated by the electric field.

FIG. 15A shows a first set of particle densities as a function of the dimensionless variable r/Λₑ. Curves 300 and 302 represent example electron and ion distributions. The electron distribution 300 is depicted as being substantially bounded at Y≈1.5Λₑ, and is thereby similar to the example plasma described above in reference to FIG. 9A. A resulting induced electrostatic field (indicated as a bracket 304) covers a substantial portion of the plasma.

FIG. 15B shows a second set of particle densities where an electron density distribution 306 is substantially bounded at an example value of Y≈10Λₑ. An ion density distribution 308 is shown to extend beyond the boundary Y. thereby inducing an electrostatic field that influences a region 310 near the outer boundary of the plasma.

FIG. 15C shows a third set of particle densities where an electron density distribution 312 is substantially bounded at an example value of Y≈40Λₑ. An ion density distribution 314 is shown to extend beyond the boundary Y. thereby inducing an electrostatic field that influences a region 316 near the outer boundary of the plasma.

In various plasma embodiments, the electric field coverage scales (304, 310, 316) are generally similar, and can be on the order of few electron scale lengths. Thus, one way to characterize a role of the electrostatic field in the stability of the plasma is to consider the electric field as a layer formed near the surface of the plasma volume. In systems where a plasma volume dimension (e.g., radius a in cylindrical systems) is on the order of the E-field layer “thickness” (such as the system of FIG. 15A), the influence of the electrostatic field is substantial with respect to the overall plasma. Consequently, an energy stability facilitated by the electrostatic field can be more pronounced in such systems.

In systems where a plasma volume dimension is substantially larger than the E-field layer “thickness” (such as the systems of FIGS. 15B and C), the influence of the electrostatic field may not be as substantial when compared to systems such as that of FIG. 15A. Consequently, electrostatic fields can provide significant contributions to energy stabilities; however, such contributions are typically not expected to be as pronounced as that of a smaller system.

One aspect of the present teachings relates to a plasma having a substantially larger scale length (skin depth) than that of plasmas where the induced electrostatic field is on the order of an electron scale length (electron skin depth). FIG. 15D shows an example plasma 400 having an ion distribution bounded at an inner boundary 402 and an electron distribution bounded at an outer boundary 404, thereby inducing an electrostatic field 406 that points radially outward. One can see that in such a plasma, roles of the electrons and ions are reversed.

In such a role-reversed plasma, ions act as charge carriers, thereby being subject to magnetic confinement. The value of a for the ions-moving plasma would be many times that for the electrons-moving plasma because of the much larger ion skin depth Λᵢₒₙ=(mᵢₒₙ/μₒN₀e²)^{1/2}. For plasmas having a similar average density value, the ratio of Λᵢₒₙ/Λₑ=(mᵢₒₙ/mₑ)^{1/2}. For deuterium, the ratio Λᵢₒₙ/Λₑ is approximately 61. Thus, a plasma having moving ions would have a volume of approximately 61²=3700 times that of the similar electrons-moving plasma, all else being substantially the same. The energy variational method described herein can be modified readily for analysis, and a resulting plasma system likely would be sufficiently large to allow power production.

As described above in connection with FIGS. 1-15, the induced electrostatic field can form in a plasma having a wide range of volume scale length. For a plasma where the electrons are magnetically confined, the volume scale length can be represented by the electron confinement dimension Y. In one embodiment, the volume scale length can range from approximately 1 Λₑ to approximately 1000 Λₑ. In one embodiment, the volume scale length can range from approximately 1 Λₑ to approximately 100 Λₑ. In one embodiment, the volume scale length can range from approximately 1 Λₑ to approximately 60 Λₑ. In one embodiment, the volume scale length can range from approximately 1 Λₑ to approximately 40 Λₑ. In one embodiment, the volume scale length can range from approximately 1 Λₑ to approximately 10 Λₑ. In one embodiment, the volume scale length can range from approximately 1 Λₑ to approximately 2 Λₑ. Similar volume scale length characterization can be applied to the plasma where the ions are confined.

As described above in connection with FIGS. 1-15, the induced electrostatic field formed in the plasma facilitates formation of a stable plasma state. In particular, the electrostatic field comprises a radially directed field. As is known, dynamic (as opposed to static) radial electric fields are known to exist in large systems such as tokamaks. However, such dynamic radial fields are not due to the significant separation of the charges. Rather, such dynamic radial fields are the result of imbalances in the ion Lorentz and ion pressure forces, and the dynamic field magnitudes appear to be smaller than the magnitudes of induced static electric field (by charge separation) by a factor of roughly 10.

As described above in connection with FIGS. 1-15, electrostatic field-facilitated stable plasma can be formed by magnetic confinement of electrons or ions. In such configurations, the magnetically confined particles act as charge carriers. Thus, when electrons act as charge carriers, electrons are magnetically confined; when ions act as charge carriers, ions are magnetically confined.

Being a charge carrier in the plasma can be characterized in different ways. One way is to say that charge carriers cause a current in the plasma. Another way is to say that charge carriers undergo a bulk motion in the plasma. Yet another way is to say that charge carriers flow in the plasma.

In one embodiment, both the electrons and the ions can act as charge carriers. That is, both the electrons and the ions can contribute to the current, undergo bulk motions, and flow in the plasma. A difference in the degrees of a current-producing characteristic of the two species can give rise to one species being confined magnetically more than the other. Such a difference in the magnetic confinements of the two species can induce a charge separation that causes formation of an electrostatic field in the plasma.

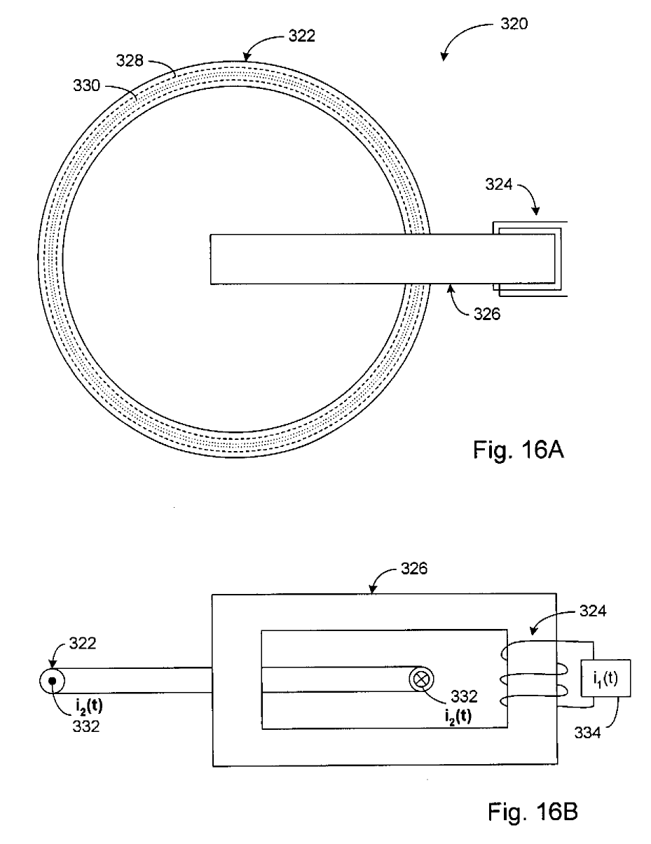

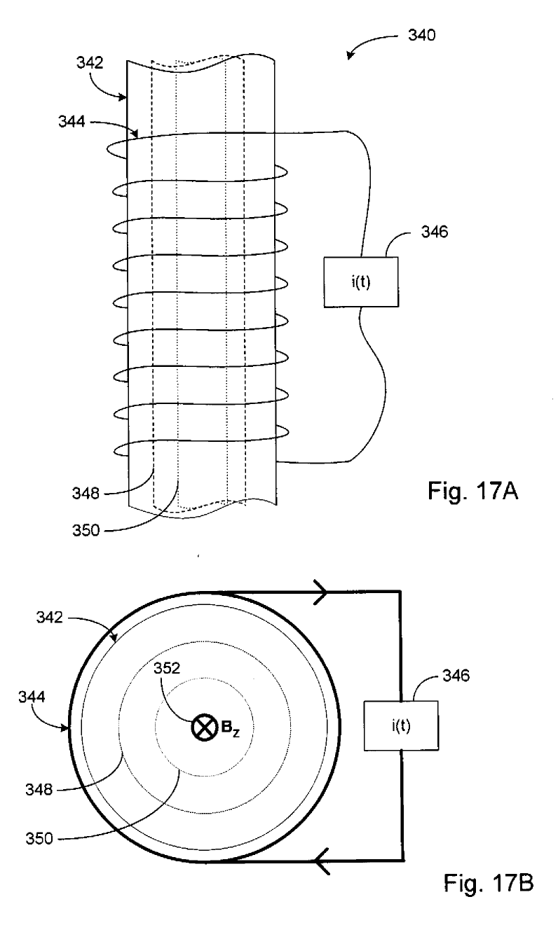

FIGS. 16 and 17 now show simplified diagrams of plasma containment devices that can magnetically contain a plasma having the substantial electrostatic field induced therein. FIGS. 16A and B show a simplified Z-pinch device 320 having a containment ring 322 magnetically coupled to a primary winding 324 via a core 326. Charge carriers in the ring 322 act as a secondary winding on a transformer core 326, such that a primary current i₁(t) established in the primary winding 324 (via a power supply 334) induces a secondary current i₂(t) 332 within the ring 322. Such a toroidal current (an axial current in the cylindrical approximation) confines the plasma as described above in reference to FIG. 4A. Appropriately selected dimension of the ring 322 and appropriately selected parameters for plasma therein results in the separation of an electron density distribution 330 from an ion density distribution 328, thereby inducing the substantial electrostatic field.

FIGS. 17A and B show a simplified theta-pinch device 340 having a containment section 342 with a winding 344 thereabout. A current i(t) can be generated by a power supply 346 and be passed through the winding 344, thereby forming an axial magnetic field B_{Z} 352 (toroidal field in a toroidal system). As described above in reference to FIG. 4B, such a magnetic field can confine the plasma via a theta-pinch. Appropriately selected dimension of the confinement section 342 and appropriately selected parameters for plasma therein can result in the separation of an electron density distribution 350 from an ion density distribution 348, thereby inducing the substantial electrostatic field.

As previously described, the Z- and theta-pinches can be combined to yield a screw-pinch. Thus, the Z and theta pinch devices of FIGS. 16 and 17 can be combined to yield a screw-pinch device. Furthermore, such confinement methods and various concepts disclosed herein can be implemented in any containment devices having a confinement section that can be approximated by a cylindrical geometry.

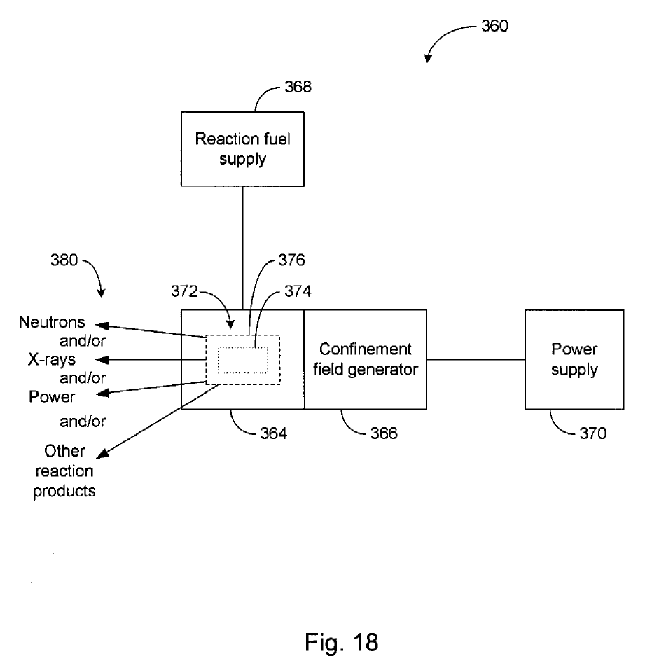

FIG. 18 now shows one embodiment of a fusion reaction apparatus 360 that can be based on a contained plasma of the present teachings. The reaction apparatus 360 includes a reaction chamber 364 that includes a magnetic field that confines a plasma 372 substantially within the reaction chamber 364. Such a magnetic field can be generated by a confinement field generator component 366 that is electromagnetically coupled to the plasma 372. The field generator component 366 is powered by a power supply 370. The reaction apparatus 360 further includes a reaction fuel supply that provides and/or maintains a reaction fuel for the plasma 372.

As shown in FIG. 18, the plasma 372 embodies an electron distribution 374 that is at least partially separated from an ion distribution 376. Such a contained plasma allows at least the reaction chamber 364 to have a relatively small dimension as described above.

The plasma 372 contained in the foregoing manner can undergo a nuclear fusion reaction that can yield neutrons, x-rays, power, and/or other reaction products. Some of the possible reaction configurations and products for an example deuterium-tritium (DT) reaction at various example operating conditions are summarized in Tables 1-3.

Table 1 summarizes various dimensions associated with an electron-scaled high aspect ratio toroidal system at various particle densities. Quantities associated with Table 1 are defined as follows: n=average particle density; Λ=electron scale length; Y=electron fluid boundary radius=set to 1.5Λ; a=toroid's minor radius=ion fluid boundary radius=set to 2.5Y; R=toroid's major radius=set to 20a; V=toroid's volume=2π²Ra².

TABLE 1

| | | | | | |
|---|---|---|---|---|---|
| n (m⁻³) | 1.00 × 10¹⁹ | 1.00 × 10²⁰ | 1.00 × 10²¹ | 1.00 × 10²² | 1.00 × 10²³ |
| Λ (cm) | 1.68 × 10⁻¹ | 5.32 × 10⁻² | 1.68 × 10⁻² | 5.32 × 10⁻³ | 1.68 × 10⁻³ |
| Y (cm) | 2.52 × 10⁻¹ | 7.98 × 10⁻² | 2.52 × 10⁻² | 7.98 × 10⁻² | 2.52 × 10⁻² |
| a (cm) | 6.31 × 10⁻¹ | 2.00 × 10⁻¹ | 6.31 × 10⁻² | 2.00 × 10⁻² | 6.31 × 10⁻³ |
| R (cm) | 1.26 × 10¹ | 3.99 × 10⁰ | 1.26 × 10⁰ | 3.99 × 10⁻¹ | 1.26 × 10⁻¹ |
| V (cm³) | 9.90 × 10¹ | 3.13 × 10⁰ | 9.90 × 10⁻² | 3.13 × 10⁻³ | 9.90 × 10⁻⁵ |

Table 2 summarizes various neutron production rate estimates with the system of Table 1 at various temperatures. Quantities associated with Table 2 are defined as follows: T=plasma temperature; σv=reaction rate; neutron rate=n²(σv)V/4. These reaction rate and neutron rate expressions are well known in the art.

TABLE 2

| T | σν | Neutron rate (s⁻¹) | | | | |
|---|---|---|---|---|---|---|
| (keV) | (cm³/s) | n = 10¹⁹ m⁻³ | n = 10²⁰ m⁻³ | n = 10²¹ m⁻³ | n = 10²² m⁻³ | n = 10²³ m⁻³ |
| 1 | 5.50 × 10⁻²¹ | 1.36 × 10⁷ | 4.30 × 10⁷ | 1.36 × 10⁸ | 1.36 × 10⁸ | 1.36 × 10⁹ |
| 2 | 2.60 × 10⁻¹⁹ | 6.44 × 10⁸ | 2.03 × 10⁹ | 6.44 × 10⁹ | 2.03 × 10¹⁰ | 6.44 × 10¹⁰ |
| 5 | 1.30 × 10⁻¹⁷ | 3.22 × 10¹⁰ | 1.02 × 10¹¹ | 3.22 × 10¹¹ | 1.02 × 10¹² | 3.22 × 10¹² |
| 10 | 1.10 × 10⁻¹⁶ | 2.72 × 10¹¹ | 8.61 × 10¹¹ | 2.72 × 10¹² | 8.61 × 10¹² | 2.72 × 10¹³ |
| 20 | 4.20 × 10⁻¹⁶ | 1.04 × 10¹² | 3.29 × 10¹² | 1.04 × 10¹³ | 3.29 × 10¹³ | 1.04 × 10¹⁴ |
| 50 | 8.70 × 10⁻¹⁶ | 2.15 × 10¹² | 6.81 × 10¹² | 2.15 × 10¹³ | 6.81 × 10¹³ | 2.15 × 10¹⁴ |
| 100 | 8.50 × 10⁻¹⁶ | 2.10 × 10¹² | 6.65 × 10¹² | 2.10 × 10¹³ | 6.65 × 10¹³ | 2.10 × 10¹⁴ |

Table 3 summarizes various power production estimates with the system of Table 1 at various temperatures for a deuterium-tritium device. Quantities associated with Table 3 are defined as follows: T=plasma temperature; power associated with charged particles=(n_{D}n_{T}σv)(5.6×10⁻¹³) (Watts). The power expression is well known in the art.

TABLE 3

| T | Power (W) | | | | |
|---|---|---|---|---|---|
| (keV) | n = 10¹⁹ m⁻³ | n = 10²⁰ m⁻³ | n = 10²¹ m⁻³ | n = 10²² m⁻³ | n = 10²³ m⁻³ |
| 1 | 7.62 × 10⁻⁶ | 2.41 × 10⁻⁵ | 7.62 × 10⁻⁵ | 2.41 × 10⁻⁴ | 7.62 × 10⁻⁴ |
| 2 | 3.60 × 10⁻⁴ | 1.14 × 10⁻³ | 3.60 × 10⁻³ | 1.14 × 10⁻² | 3.60 × 10⁻² |
| 5 | 1.80 × 10⁻² | 5.70 × 10⁻² | 1.80 × 10⁻¹ | 5.70 × 10⁻¹ | 1.80 × 10⁰ |
| 10 | 1.52 × 10⁻¹ | 4.82 × 10⁻¹ | 1.52 × 10⁰ | 4.82 × 10⁰ | 1.52 × 10¹ |
| 20 | 5.82 × 10⁻¹ | 1.84 × 10⁰ | 5.82 × 10⁰ | 1.84 × 10¹ | 5.82 × 10¹ |
| 50 | 1.21 × 10⁰ | 3.81 × 10⁰ | 1.21 × 10¹ | 3.81 × 10¹ | 1.21 × 10² |
| 100 | 1.18 × 10⁰ | 3.72 × 10⁰ | 1.18 × 10¹ | 3.72 × 10¹ | 1.18 × 10² |

As an example from Tables 1-3, not to be construed as limiting in any manner, consider a plasma system having a DT fuel confined in a high aspect ratio toroidal chamber. An average number density n of approximately 10²⁰ m⁻³ corresponds to an electron scale length Λ of approximately 0.0532 cm. Setting Y=1.5Λₑ=0.080 cm, the minor radius a at 2.5Λₑ=0.20 cm, the major radius R at 20a =4 cm results in a volume V of approximately 3.13 cm³.

Operating such a plasma at a temperature of approximately 5 keV (where the reaction rate is approximately 1.30×10⁻¹⁷) can yield approximately 1.02×10¹¹ neutrons per second. Neutron fluxes of such an order in such a compact device are useful in many areas such as antiterrorist materials detection, well logging, underground water monitoring, radioactive isotope production, and other applications.

Operation of such a DT-fueled plasma can also yield high intensity soft x-rays having energies in a range of approximately 1-5 keV. Such x-rays from such compact device are useful in areas such as photolithography. In one embodiment, the soft x-rays are produced from the plasma even if fusion does not occur.

From Tables 1-3, one can see that the example operating parameters of 10²⁰ m^{31 3} average number density at temperature of 5 keV yields a power output of approximately 57 mW. Power output can be increased dramatically by varying different plasma parameters. As previously described, the example plasma solution in reference to FIGS. 6-10 are thought to generally hold when the average number density changes by a factor of approximately 10 and when the temperature changes by a factor of approximately 30.

As a relatively conservative estimate for a possible power increase, a change in temperature by a factor of approximately 20 yields a plasma temperature of approximately 100 keV, where power output is approximately 3.72 W when n=10 ²⁰ m^{31 3}. Additionally, as described above in connection with FIGS. 15A-C, electrostatic field facilitated stable plasmas can be formed with an increased volume. Thus, scaling both major and minor radii of the high aspect ratio toroid by a factor of 10 increases the volume by a factor of 10³. Thus, because the power output is proportional to the volume of the plasma, the foregoing example 3.72 W output device can be scaled so as to produce several kilo-Watts of power. Such a device has a major radius of approximately 40 cm, which is still a relatively compact device for a power generator.

Various example plasma devices described herein can be operated by including an example start-up process that facilitates formation of a stable and confined plasma. The example start-up process is described in context of a plasma device having a toroidal geometry where both toroidal (axial) and poloidal (azimuthal) magnetic fields play a substantial role in confinement. Similar start-up process generally applies to the Z, theta and screw pinch concepts described herein.

In one embodiment, a vacuum toroidal magnetic field is established by current-carrying toroidal field coils wound in the poloidal direction (such as that shown in FIGS. 17A and B). Next, neutral gas is puffed into the vacuum chamber and a forced breakdown ionizes the gas yielding a relatively cold and substantially neutral plasma. In a time short compared to the recombination time of electrons and ions, the current in the primary winding of a transformer (such as that shown in FIGS. 16A and B) is ramped up. A change in magnetic flux through the central portion of the torus induces a toroidal (axial) current which produces a poloidal (azimuthal) magnetic field. This current can cause resistive Joule heating of the plasma to approximately 2-3 keV.

Thus, the foregoing example start-up process can bring the plasma into a parameter regime of substantial densities and temperatures that characterize the plasma environment. Subsequently, the plasma proceeds toward a stable, confined equilibrium configuration via relaxation processes with the concomitant development of a substantial, radial electrostatic field that provides confinement for the ions. Additional heating mechanisms such as radio frequency heating can be used to further increase the plasma temperature and hence the probability of fusion events occurring in the plasma environment.

Although the above-disclosed embodiments have shown, described, and pointed out the fundamental novel features of the invention as applied to the above-disclosed embodiments, it should be understood that various omissions, substitutions, and changes in the form of the detail of the devices, systems, and/or methods shown may be made by those skilled in the art without departing from the scope of the invention. Consequently, the scope of the invention should not be limited to the foregoing description, but should be defined by the appended claims.

What is claimed is:

1. A method for designing a plasma confinement device, comprising:
generating a characterization of the total energy of a plasma system comprising a distribution of electrons and a distribution of ions, wherein said characterization includes an electric energy term associated with a bulk electrostatic field induced inside the plasma by dissimilarities between said distribution of electrons and said distribution of ions;
determining an equilibrium state associated with said characterization of the total energy of the plasma system; and
determining one or more plasma parameters associated with said equilibrium state.

2. The method of claim 1, wherein said one or more plasma parameters comprises a particle number density and a volume scale length.

3. A method of plasma containment, comprising:
providing a plasma system comprising a plurality of charged first particles and a plurality of charged second particles;
creating a dissimilarity between the overall distributions of the first and second particles.

4. The method of claim 3, further comprising inducing a bulk electrostatic field inside the plasma from the creation of the dissimilarity.

5. The method of claim 4, further comprising characterizing the total energy of the plasma system, the characterization including an electric energy term associated with the bulk electrostatic field.

6. The method of claim 5, further comprising determining an equilibrium state associated with the characterization of the total energy of the plasma system.

7. The method of claim 6, further comprising restricting the plasma to a first beta value and a second beta value, the first and second beta values depending on factors comprising average particle number density, average plasma temperature, and strength of a magnetic field established in the plasma, and wherein the inverse of the first beta value is between approximately 0 and 22 and the inverse of the second beta value is between approximately 0 and 3.

8. The method of claim 7, further comprising determining a first particle skin depth and confining the first particles within a substantially cylindrical volume of radius between 1 and 2 first particle skin depths.

9. The method of claim 7, further comprising determining a first particle skin depth and confining the first particles within a substantially toroidal volume of minor radius between 1 and 2 first particle skin depths.

10. A method of plasma containment, comprising:
providing a plasma comprising a plurality of first particles and a plurality of second particles;
confining the first particles substantially to a first volume;
confining the second particles substantially to a second volume, the second volume being larger than and encompassing the first volume.

11. The method of claim 10, wherein movement of the first particles creates an electric current, and wherein confining the first particles substantially to the first volume comprises establishing a magnetic field in the plasma substantially perpendicular to the direction of the current.

12. The method of claim 10, wherein confining the second particles substantially to the second volume comprises separating the bulk distributions of the first particles and the second particles such that a bulk electrostatic field is created in the plasma between the first particles and the second particles.

13. A method for plasma containment, comprising:
providing a plasma comprising a plurality of charged first particles and a plurality of charged second particles, the first particles establishing a current by acting as charge carriers in the plasma;
creating a magnetic field in the plasma, the magnetic field being oriented substantially perpendicular to the current, the magnetic field acting on the first particles to create a dissimilarity in distributions between the first particles and the second particles within the plasma.

14. The method of claim 13, wherein the first particles comprise electrons and the second particles comprise ions.

15. The method of claim 13, wherein the first particles comprise ions and the second particles comprise electrons.

16. The method of claim 13, further comprising containing the plasma within a substantially cylindrical volume, the volume defining an axial direction and an azimuthal direction.

17. The method of claim 13, further comprising containing the plasma within a substantially toroidal volume, the volume defining a toroidal direction and a poloidal direction.

18. The method of claim 16, wherein the current flows in an axial direction and the magnetic field is oriented in an azimuthal direction.

19. The method of claim 16, wherein the current flows in an azimuthal direction and the magnetic field is oriented in an axial direction.

20. The method of claim 16, wherein the current flows in a combined axial-azimuthal direction and the magnetic field is oriented in a combined aximuthal-axial direction.

21. The method of claim 16, wherein the current flows in a helical direction and the magnetic field is oriented in a helical direction.

22. A method for plasma containment, comprising:
providing a plasma comprising a plurality of charged first particles and a plurality of charged second particles, the first particles being charge carriers of a current in the plasma;
establishing a magnetic field in the plasma that electromagnetically influences the position of the first particles more than it influences the position of the second particles;
confining the first particles substantially to a first volume under the influence of the magnetic field;
maintaining at least a portion of the second particles outside the first volume.

23. The method of claim 22, wherein the position of the first particles is electromagnetically influenced through a Z pinch.

24. The method of claim 22, wherein the position of the first particles is electromagnetically influenced through a theta pinch.

25. The method of claim 22, wherein the position of the first particles is electromagnetically influenced through a screw pinch.

26. The method of claim 22, further comprising establishing a bulk electrostatic field within the plasma and confining the second particles to a second volume, the first volume being smaller than and contained within the second volume, under the influence of the bulk electrostatic field.

27. A method for plasma containment, comprising:
providing a plasma comprising a plurality of charged first particles and a plurality of second particles, the second particles being of opposite charge to the first particles;
urging the first particles in a direction such that they establish a current;
establishing a magnetic field in the plasma;
confining the first particles substantially within a first volume through a force imposed on the first particles by the magnetic field;
maintaining at least a portion of the second particles outside the first volume, thus creating a separation in the bulk distributions of the first and second particles;
establishing a bulk electrostatic field within the plasma due to the bulk distribution separation of the first and second particles;
confining the second particles substantially to a second volume, the first volume being smaller than and enclosed within the second volume, through a force imposed on the second particles by the electrostatic field.
